(19) United States
(12) Patent Application Publication
(10) Pub. No.: US 2024/0142353 A1
(43) Pub. Date: May 2, 2024

(54) METHOD AND DEVICE FOR MEASURING MECHANICAL STRENGTH OF A PRESSURIZED GAS STORAGE TANK FOR A VEHICLE

(71) Applicant: PLASTIC OMNIUM NEW ENERGIES FRANCE, Lyon (FR)

(72) Inventors: Mathieu JONGBLOEDT, Bruxelles (BE); Rémi THEBAULT, Bruxelles (BE); Joris BEERDEN, Bruxelles (BE)

(73) Assignee: PLASTIC OMNIUM NEW ENERGIES FRANCE, Lyon (FR)

(21) Appl. No.: 18/546,825

(22) PCT Filed: Feb. 21, 2022
(86) PCT No.: PCT/EP2022/054241

§ 371 Date: Aug. 17, 2023

(30) Foreign Application Priority Data
Feb. 19, 2021 (LU) LU 102542

(51) Int. Cl. G01N 3/12

(52) U.S. Cl. CPC G01N 3/12

(57) ABSTRACT

A method for measuring mechanical strength of a pressurized gas storage tank for a vehicle is provided, the method including providing a tank having at least one opening, introducing an expandable element into the tank via the opening, connecting the expandable element to a pipe for a liquid, filling the expandable element with liquid, exerting a pressure, Pᵢₙₜ, on all interior walls of the tank by means of the expandable element filled with liquid, measuring a possible deformation of the tank, emptying the liquid contained in the expandable element, and removing the expandable element from the tank via the opening. Also provided is a device for measuring mechanical strength of a pressurized gas storage tank for a vehicle.

The invention relates to the field of vehicles, such as for example motor vehicles, trucks, buses, trains, airplanes, motorcycles or even boats. The invention relates more particularly to a method for measuring mechanical strength of a pressurized gas storage tank for a vehicle. The invention also relates to a device for measuring mechanical strength of a pressurized gas storage tank for a vehicle.

A pressurized gas storage tank for a vehicle conventionally consists of an inner envelope referred to as liner, which has a function of sealing against the gas contained in the tank. The liner includes at least one opening, which is topped by a connector. The liner and the connector are surrounded by a reinforcement structure, generally made by winding strips of thermosetting polymer-based composite material, for example epoxy or polyurethane resin-based, filled with glass and/or carbon fibers. Thus, the “plastic” liner comprises at least one opening for filling and emptying the tank. It is manufactured by injection or by rotational molding or by extrusion blow molding of a thermoplastic or thermosetting polymer (abbreviated to “thermoset”) such as for example polyethylene, polyamide, polyphthalamide, polyurethane, silicone. Such a tank is said to be of type IV. Alternatively, the tank simply consists of a shell made of a thermoplastic composite without a liner. Such a tank is said to be of type V.

Such pressurized gas storage tanks for a vehicle are subjected to mechanical strength tests. These tests consist in subjecting said tanks to pressures, Pᵢₙₜ, of the order of 1.5 times the nominal pressure, Pₙ. This nominal pressure, Pₙ, is generally of the order of 350 to 700 bar depending on the use of the pressurized gas storage tanks for a vehicle.

During the mechanical strength tests of the pressurized gas storage tanks for a vehicle, said tanks are pressurized using a liquid, generally water. The tanks to be tested are filled with the liquid and the pressure exerted, Pᵢₙₜ, is increased to 1.5 times the nominal pressure, Pₙ. The deformation of the tank is measured once the test pressure, Pᵢₙₜ, is reached or after a certain period of keeping the tank at the test pressure, Pᵢₙₜ. Such mechanical strength tests correspond in particular to measurements of elastic and permanent expansions, as described in European standard EC79.

At the end of the mechanical strength tests, the tanks are emptied of the test liquid and must be dried in particular with a view to being used for pressurized gas storage. The operation of drying the tanks is relatively time-consuming and complex because the drying must be complete. This significantly lengthens the production cycle times. Furthermore, the pressurized gas storage tanks for a vehicle sometimes comprise a “liner” made of polyamide, which is a water-sensitive polymer due to its ability to absorb the latter, thus modifying the properties of the polyamide.

The invention aims in particular to overcome these disadvantages of the prior art.

More specifically, an objective of the invention, in at least one of its embodiments, is to implement a method for measuring mechanical strength of a pressurized gas storage tank for a vehicle which has shorter cycle times than the existing methods.

Another objective of the invention, in at least one of its embodiments, is to provide a device for measuring mechanical strength of a pressurized gas storage tank for a vehicle.

In accordance with a particular embodiment, the invention relates to a method for measuring mechanical strength of a pressurized gas storage tank for a vehicle.

According to the invention, such a method comprises at least the following steps:
Providing a pressurized gas storage tank for a vehicle having at least one opening;
Stretching an expandable element in the lengthwise direction;
Introducing the expandable element into the pressurized gas storage tank for a vehicle via the at least one opening, referred to as first opening;
Connecting the expandable element to a pipe for a liquid;
Filling the expandable element with liquid;
Exerting a pressure, Pᵢₙₜ, on all the interior walls of the pressurized gas storage tank for a vehicle by means of the expandable element filled with liquid;
Measuring a possible deformation of the pressurized gas storage tank for a vehicle;
Emptying the liquid contained in the expandable element;
Removing the expandable element from the pressurized gas storage tank for a vehicle via the at least one opening, referred to as first opening.

The general principle of the invention is based on the use of an expandable element inserted into the pressurized gas storage tank for a vehicle during the mechanical strength test. This expandable element is filled with liquid during the test and allows the pressurized gas storage tank for a vehicle to be pressurized while avoiding direct contact between the liquid and the interior walls of the pressurized gas storage tank for a vehicle.

Thus, the invention is based on an entirely novel and inventive approach to implementing a method for measuring mechanical strength of a pressurized gas storage tank for a vehicle that does not require a long step of drying the tank tested after performing the test and making it possible to avoid potential degradation of the liner constituting the interior of the tank. Indeed, when the expandable element is removed from the pressurized gas storage tank for a vehicle after the test, the interior walls are still dry. Furthermore, the method according to the invention makes it possible to avoid the use of a drying device and thus reduces the cost of producing and testing a pressurized gas storage tank for a vehicle.

The expandable element is impermeable to liquid. The expression impermeable to liquid is understood to mean that during the performance of the test the liquid does not come into contact with the interior walls of the pressurized gas storage tank for a vehicle by diffusion through the expandable element. The expandable element is for example a sheet of large area able under the effect of the weight of the liquid to cover the interior walls of the pressurized gas storage tank for a vehicle.

A discharge of the gas contained in the expandable element and, if needed, of the gas included in the tank is provided during the step of filling the expandable element with the liquid. This discharge is carried out with a gas discharge means. This gas is for example air or a tracer gas. A tracer gas advantageously makes it possible to combine the mechanical strength test with a leak test of the pressurized gas storage tank for a vehicle. Indeed, if for example a volume of tracer gas is enclosed between the expandable element and the inner wall of the tank, pressurizing the expandable element causes the pressurization of this volume of tracer gas. Then, in the event of a leak, it is possible to detect the tracer gas outside the pressurized gas storage tank for a vehicle. In addition, since the volume of tracer gas brought to high pressure is reduced compared with existing leak test methods, the energy released in the event of the tank breaking is reduced, which simplifies the sizing of the safety devices. This results in a significant gain in cycle time, investment and consumables specific to the leak test.

The step of connecting the expandable element is preferably carried out before the step of introducing the expandable element into the pressurized storage tank via the at least one opening.

The step of measuring a possible deformation of the pressurized gas storage tank for a vehicle is for example a dimensional measurement such as a measurement of the diameter and the length of the tank. This dimensional measurement can be carried out using a camera, a 3D scanner, a distance measurement using a laser or a probe of the LVDT (Linear Variable Differential Transformer) type, by contact with a comparator-type system. According to another example, the measurement of a possible deformation of the pressurized gas storage tank for a vehicle is a volumetric measurement corresponding to the measurement of the amount of liquid added during the pressure increase. If the measurement of a possible deformation of the pressurized gas storage tank for a vehicle is a dimensional measure, it must make it possible to calculate a volumetric expansion. This step of measuring a possible deformation of the pressurized gas storage tank for a vehicle is intended to determine that the volumetric expansion is maintained within a tolerance range. Said tolerance range is such that a tank must not deform by more than 10% of the average deformation of all the tanks of the same production batch.

Advantageously, the method for measuring mechanical strength of a pressurized gas storage tank for a vehicle is such that the expandable element is a bladder.

Thus, a bladder-type expandable element allows easier insertion of the expandable element into the pressurized gas storage tank for a vehicle.

The method for measuring mechanical strength of a pressurized gas storage tank for a vehicle is such that it comprises a step of stretching the expandable element in the lengthwise direction.

Thus, stretching the expandable element in the lengthwise direction allows easier insertion of the latter into the tank via the opening, referred to as first opening, more particularly when the expandable element is a bladder having an outside diameter that is wider than the inside diameter of the opening of the tank, referred to as first opening, through which it is inserted. Such a step makes it possible to reduce the outer diameter of the bladder by stretching in the lengthwise direction. Additionally, stretching the expandable element in the lengthwise direction makes it possible to even out the stresses applied to the expandable element when it is pressurized. The pressure, Pᵢₙₜ, applied to all the interior walls of the pressurized gas storage tank for a vehicle is then uniform, which contributes to making reliable and improving the reproducible nature of the method for measuring mechanical strength.

This step of stretching in the lengthwise direction is carried out before, during or after the expandable element is inserted into the pressurized gas storage tank for a vehicle, thus making it possible to place the expandable element more quickly in contact with all the interior walls of the pressurized gas storage tank for a vehicle and in particular the bottom of the tank. Thus, in the case of an expandable element in the form of a bladder having an outside diameter that is smaller than the inside diameter of the opening of the tank through which it is inserted, this step makes it possible to reduce the duration of the test. The first stretching means allowing the stretching of the expandable element is for example a pressure differential between the interior and the exterior of the bladder.

According to an advantageous embodiment of the invention, the method for measuring mechanical strength of a pressurized gas storage tank for a vehicle is such that it comprises a step of assembling a first coupling means to the expandable element.

Thus, this step of assembling a first coupling means to the expandable element makes it possible to obtain good sealing of the assembly obtained and to hold the expandable element during the step of filling the latter with the liquid. The coupling element also makes it possible to connect the internal volume of the expandable element to a device for pressurizing by the fluid.

According to a preferred embodiment of the preceding embodiment of the invention, the method for measuring mechanical strength of a pressurized gas storage tank for a vehicle is such that the step of stretching the expandable element is carried out by at least one translational movement of a first stretching means with respect to the first coupling means.

Thus, a step of stretching the expandable element carried out by at least one translational movement of a first stretching means with respect to the first coupling means makes it possible to use the first coupling means bearing against the first stretching means.

The first stretching means allowing the stretching of the expandable element can be a weight inserted into the expandable element such as a bead or else the simple weight of a part of the liquid used to carry out the mechanical strength test. The first stretching means allowing the stretching of the expandable element can also be a rod or a bar that is introduced into the opening of the pressurized gas storage tank for a vehicle following the expandable element. Alternatively, the first stretching means allowing the stretching of the expandable element can also be respectively a rod provided with a means for gripping the expandable element or else a magnetized rod for example which is introduced into the pressurized gas storage tank for a vehicle via a second opening located with respect to the tank opposite the opening, referred to as first opening, through which the expandable element is introduced. In the case of a magnetized rod, it is used in addition to a metal bead having ferromagnetic properties, the magnetized rod and the metal ball being located on either side of the expandable element.

According to a preferred embodiment of the preceding embodiment of the invention, the method for measuring mechanical strength of a pressurized gas storage tank for a vehicle is such that the first stretching means is a pipe for filling the expandable element with the liquid.

Thus, the use of a filling pipe as first stretching means makes it possible to reduce the number of operations related to the method for measuring mechanical strength of a pressurized gas storage tank for a vehicle. One and the same means used to stretch the expandable element and to fill it with the liquid.

According to a preferred embodiment of the preceding embodiment of the invention, the method for measuring mechanical strength of a pressurized gas storage tank for a vehicle is such that the pipe for filling the expandable element with the liquid has an outside diameter less than the inside diameter of the at least one opening, referred to as first opening.

Thus, such a pipe can be introduced into the tank through the at least one opening, referred to as first opening, which allows for easier filling with the liquid. Advantageously, this pipe is used to empty the liquid contained in the expandable element.

According to a preferred embodiment of the invention, the method for measuring mechanical strength of a pressurized gas storage tank for a vehicle is such that the pipe for filling the expandable element with the liquid passes through the first coupling means.

According to an advantageous embodiment of the invention, the method for measuring mechanical strength of a pressurized gas storage tank for a vehicle is such that the liquid is selected from the group of liquids consisting of water or water-based solution, preferentially the liquid is mains water, more preferentially the liquid is filtered and softened mains water.

Thus, the use of liquid selected from water or water-based solutions makes it possible to use a liquid that has high density and is readily available. Advantageously, the water contains additional solvents such as alcohol in order to obtain an azeotrope having a lower evaporation temperature than water. The use of filtered and softened mains water makes it possible to avoid the accumulation of limescale in the expandable element and/or the hydraulic circuit to which the tank is connected for the needs of the mechanical strength test.

According to an advantageous embodiment of the invention, the method for measuring mechanical strength of a pressurized gas storage tank for a vehicle is such that the expandable element is based on elastomer more particularly selected from the group consisting of acrylonitrile-butadiene rubber (NBR), hydrogenated acrylonitrile-butadiene rubber (HNBR), carboxylated nitrile (XNBR), ethylene-propylene-diene (EPDM) rubber, vinyl-methyl polysiloxane silicone (VMQ), fluorinated rubber (FKM), perfluorinated rubber (FFKM), chloroprene (CR), polyacrylate (ACM), acrylate-ethylene (AEM) and natural rubber. Preferentially, the elastomer has substantial capacity for stretching, for example capacity to stretch by about 400%. The material that constitutes the expandable element advantageously has a low coefficient of friction with the material of the inner wall of the pressurized gas storage tank so as to be able to slide freely during its expansion without creating locally excessive stretching, which could lead to a breakage of the expandable element. Advantageously, the coefficient of friction is reduced by applying a specific product onto the exterior surface of the expandable element, said product leaving no moisture and having a tendency to evaporate very quickly.

Advantageously, the internal geometry of the pressurized gas storage tank for a vehicle is free of sharp angles in order to avoid locally excessive stretching of the expandable element, which could lead to it breaking.

According to an advantageous embodiment of the invention, the method for measuring mechanical strength of a pressurized gas storage tank for a vehicle is such that the coupling means is rigidly connected to the opening, referred to as first opening, of said tank by threading.

Thus, the reaction force exerted by the pressure of the liquid during the test is better absorbed.

According to an advantageous embodiment of the invention, the method for measuring mechanical strength of a pressurized gas storage tank for a vehicle is such that the gas contained in said tank is discharged during the filling of the expandable element, said gas being air for example.

Thus, the residual gas pockets are minimized and the geometry of the expandable element after its expansion is better controlled.

The gas can be freely discharged through the opening of the pressurized gas storage tank for a vehicle or can be discharged through vents provided for this purpose in the coupling means, if the latter is rigidly connected to the opening of the tank. Finally, the gas can also be discharged via a second opening if the tank has two openings.

According to an advantageous embodiment of the invention, the method for measuring mechanical strength of a pressurized gas storage tank for a vehicle is such that it comprises, before the step that consists of filling the expandable element with liquid, a step of pre-filling the expandable element with liquid.

During pre-filling, the lower portion of the expandable element inflates to come into contact with the inner wall of the tank by expelling air out of the tank. Pre-filling thus makes it possible to prevent air pockets from being trapped between the expandable element and the tank, which could distort the method for measuring mechanical strength of the tank. This also contributes to avoiding any damage to the expandable element during the implementation of the method for measuring mechanical strength of a pressurized gas storage tank for a vehicle.

According to an advantageous embodiment of the invention, the method for measuring mechanical strength of a pressurized gas storage tank for a vehicle is such that it comprises, before the step that consists in filling the expandable element with liquid, a step of inflating the expandable element.

This inflation step makes it possible to perform uniform stretching of the expandable element in order to ensure uniform contact between the expandable element and the inner wall of the tank, thus preventing creases from forming at the surface of the expandable element. This improves the reliability and reproducibility of the method for measuring mechanical strength of a pressurized gas storage tank for a vehicle. This also contributes to avoiding any damage to the expandable element during the implementation of the method for measuring mechanical strength of a pressurized gas storage tank for a vehicle.

The invention also relates to a device for measuring mechanical strength of a pressurized gas storage tank for a vehicle, said device being able to implement the method according to the invention.

In accordance with one embodiment according to the invention, the device for measuring mechanical strength of a pressurized gas storage tank for a vehicle comprises:
an expandable element able to be inserted into the pressurized gas storage tank for a vehicle, said expandable element being able to contain a liquid once inserted into said tank;
a first coupling means able to be assembled with the expandable element, said first coupling means being able to be connected to a first means for stretching the expandable element;
a liquid pipe able to be connected to the first coupling means;
means for discharging the gas contained in the expandable element and/or the tank.

The expandable element is able to receive liquid even if it is only partially inserted into the pressurized gas storage tank for a vehicle. This is the case when the weight of the liquid allows the expandable element to be inserted into the tank.

According to an advantageous embodiment, the device for measuring mechanical strength of a pressurized gas storage tank for a vehicle is such that the expandable element is a bladder.

According to an advantageous embodiment, the device for measuring mechanical strength of a pressurized gas storage tank for a vehicle is such that the first stretching means is a rod.

According to an advantageous embodiment, the device for measuring mechanical strength of a pressurized gas storage tank for a vehicle is such that the rod is the liquid pipe, preferentially a cannula.

According to an advantageous embodiment, the device for measuring mechanical strength of a pressurized gas storage tank for a vehicle is such that it comprises a pump able to discharge the liquid contained in the expandable element.

According to an advantageous embodiment, the device for measuring mechanical strength of a pressurized gas storage tank for a vehicle is such that the expandable element comprises a zone for receiving the first coupling means.

Thus, a zone for receiving the first coupling means on the expandable element allows better assembly between the first coupling element and the expandable element. This zone can be produced in the case of a bladder embodied by the presence of protrusions on the outer wall of the bladder in a zone of smaller diameter.

According to an advantageous embodiment, the device for measuring mechanical strength of a pressurized gas storage tank for a vehicle is such that it comprises means for introducing a gas into the expandable element and/or the tank. Preferentially, the means for introducing a gas correspond to the means for discharging gas contained in the expandable element and/or the tank.

Other features and advantages of the invention will become more clearly apparent on reading the following description of a preferred embodiment, given by way of simple, illustrative and non-limiting example, and from the appended drawings, among which:

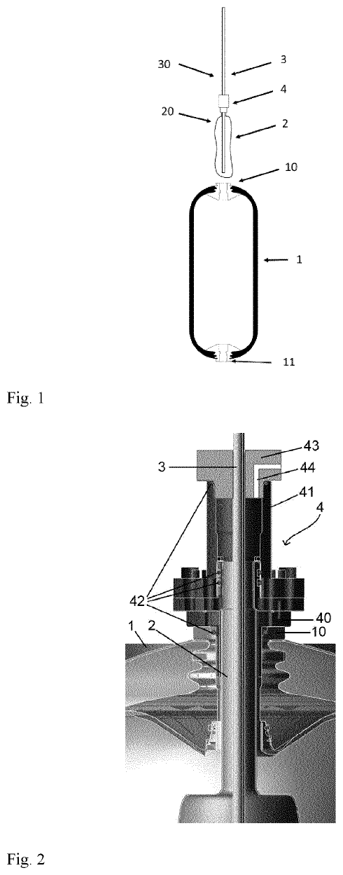

FIG. 1 illustrates the steps of providing a pressurized gas storage tank for a vehicle having at least one opening for introducing an expandable element into the pressurized gas storage tank for a vehicle via at least one opening and connecting the expandable element to a pipe of a liquid;

FIG. 2 illustrates an embodiment of a first coupling means allowing the expandable element and the liquid pipe to be connected to the at least one opening of the pressurized gas storage tank for a vehicle;

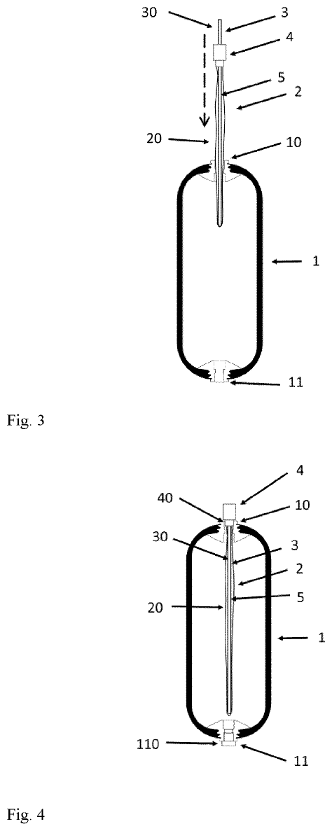

FIG. 3 illustrates the step of introducing the expandable element into the pressurized gas storage tank for a vehicle via the at least one opening;

FIG. 4 describes the end of the step of introducing the expandable element into the pressurized gas storage tank for a vehicle via the at least one opening;

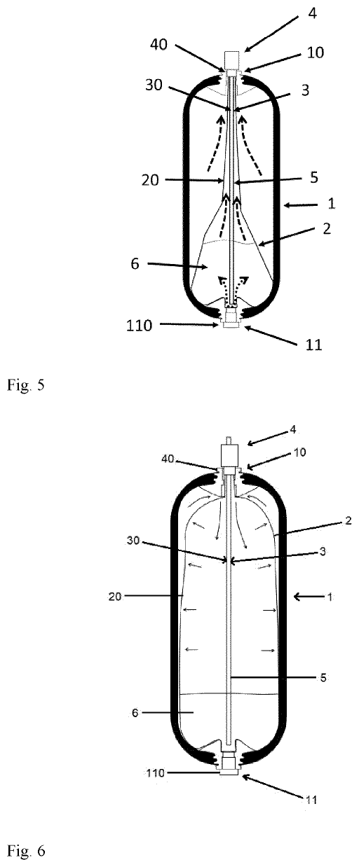

FIG. 5 illustrates the step of pre-filling the expandable element within the tank with a liquid;

FIG. 6 illustrates the step of inflating the expandable element within the tank;

FIG. 7 illustrates the step of filling the expandable element within the tank with the liquid; and

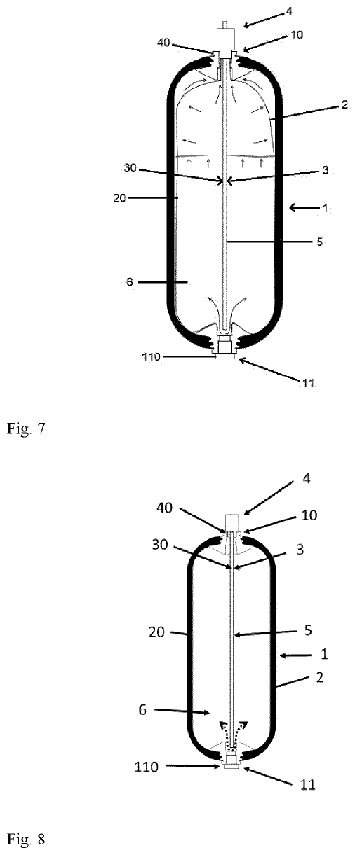

FIG. 8 illustrates the end of the filling step and the start of the pressurization, Pᵢₙₜ, of all the interior walls of the tank by means of the expandable element filled with liquid.

Referring to FIG. 1, it presents an embodiment of the steps of providing a pressurized gas storage tank for a vehicle 1 comprising at least one opening 10 and connecting the expandable element 2 to a pipe of a liquid 3 according to the invention. The opening 10 is topped by a metal connector making it possible to connect the tank 1 to the filling and/or emptying circuit of the tank (not shown). The pressurized gas storage tank for a vehicle 1 subjected to the mechanical strength test comprises at least one opening 10, referred to as first opening, through which the expandable element 2 will be introduced, said element being a bladder 20 made of elastomeric material. The tank comprises a second opening 11 located opposite the opening 10 through which the expandable element 2 will be introduced. The second opening 11 is topped by a metal connector making it possible to connect the tank 1 to the filling and/or emptying circuit of the tank (not shown). This second opening 11 is left open. The bladder 20 made of elastomeric material is connected to a liquid pipe 3. The liquid pipe 3 is in the form of a cannula 30. The bladder 20 is sealingly assembled with a first coupling means 4. The liquid pipe 3 passes through the first coupling means 4. This liquid pipe 3 can protrude outside the bladder 20 by a distance equivalent to the internal length of the tank 1, for example by more than 2 m. For shorter tanks, it will protrude less. The length of this liquid pipe 3 inside the bladder 2 in the case of a rigid cannula is less than the length of the tank to be tested, preferentially the length of this liquid pipe 3 inside the rigid bladder 2 is close to the length of the tank to be tested, so as to stretch the expandable element 2 up to a distance from the opposite part of the tank 1, the opposite part with respect to the opening 10, referred to as first opening, being equivalent to approximately the inner radius of the tank 1. In this way, the expandable element 2 can stretch in a manner that is approximately uniform in all directions.

FIG. 2 illustrates an embodiment of the first coupling means 4. The first coupling means 4 comprises a main body 41 which is hollow so that the liquid pipe 3 can run through the entire length thereof. The main body 41 can further house an end part of the expandable element 2, that is open, so that it is positioned in the main body 41 and around the liquid pipe 3.

The first coupling means 4 is configured to be able to be attached, herein by screwing, in a sealed manner in the at least one opening 10 of the pressurized gas storage tank for a vehicle 1. To this end, the first coupling means 4 comprises at least one annular seal 42 making it possible to ensure the sealing of the connection between the main body 41 and the pressurized gas storage tank for a vehicle 1. The first coupling means 4 is further configured to ensure tight and sealed attachment of the end portion of the expandable element 2 in the main body 41. This seal is provided herein by other annular seals 42.

The first coupling means 4 comprises a filling member 43 which is removably attached partially inside the main body 41, the seal being provided herein by means of an additional annular seal 42. The filling member 43 comprises an air passage 44 making it possible, alternatively, to inject air into the expandable element 2 and to empty the expandable element 2 of the air it contains. The filling member 43 includes an expander (not shown) configured to regulate the air pressure inside the expandable element during the filling and emptying thereof.

FIG. 3 illustrates an embodiment of the step of introducing the expandable element 2 into the pressurized gas storage tank for a vehicle 1 via the at least one opening 10. Before implementing this step of introducing the expandable element 2, which is a bladder 20 made of elastomeric material, said bladder is stretched in the lengthwise direction by moving a first stretching means 5. The step of stretching the expandable element 2 is carried out by at least one translational movement of a first stretching means 5 with respect to the first coupling means 4. This movement is depicted by the arrow in dashed lines. This stretching step reduces the cross-section of the expandable element 2 and thus makes it easier to introduce the bladder 20 into the tank 1 via the opening 10, referred to as first opening. The first stretching means advantageously consists of the liquid pipe 3 in the form of a cannula 30. During this step, the second opening 11 is left open.

FIG. 4 illustrates the end of the step of introducing the expandable element 2 into the pressurized gas storage tank for a vehicle 1 via the at least one opening 10. It is observed that the movement of the first stretching means 5 is finished, said first stretching means 5 comprising the liquid pipe 3 being in the form of a cannula 30. At the end of the step of introducing the expandable element 2 into the pressurized gas storage tank for a vehicle 1, the first coupling means 4 is positioned on the at least one opening 10, referred to as first opening. The first coupling means 4 comprises a closure means 40 able to be inserted into the at least one opening 10, referred to as first opening. The first coupling means 4 can thus for example be screwed into the opening 10 in order to be rigidly connected to the tank and thus not to retract under the pressure force during the mechanical strength test. The expandable element 2, which is a bladder 20 made of elastomeric material, is still free of liquid. The second opening 11, which was open, is then closed by means of a second closure means 110. To control the positioning of the expandable element 2 in the tank 1, the first stretching means 5 is moved until it comes into abutment against the second closure means 110, so that the first stretching means 5 and the expandable element 2 bear against the second closure means 110.

FIG. 5 illustrates the step of pre-filling the expandable element 2 within the pressurized gas storage tank for a vehicle 1 with a liquid 6. The expandable element 2 which is a bladder 20 made of elastomeric material is filled via the liquid pipe 3 which takes the form of a cannula 30, said liquid pipe 3 having served as first stretching means 5 of the expandable element 2. The liquid pipe 3 passes through the first coupling means 4. The first coupling means 4 comprises a closure means 40 inserted into the at least one opening 10, referred to as first opening. During this pre-filling step, the expandable element 2 is filled with liquid at about 10% of the internal volume of the tank 1 by means of the liquid pipe 3. As depicted in FIG. 5, the length of the liquid pipe 3 makes it possible to introduce the liquid into the expandable element in the lower part thereof. Therefore, the lower part of the expandable element 2 expands to come into contact with the internal wall of the tank 1 by expelling the air outside the tank via the air passage 44 of the filling member 43, the movement of this air being depicted by the arrows in dashed lines. The pre-filling thus makes it possible to prevent air pockets from being trapped between the expandable element 2 and the inner wall of the tank 1, which could distort the method for measuring mechanical strength of the tank. The dotted arrows indicate the inlet of liquid 6 into the bladder 20. The liquid used is selected from the group of liquids consisting of water or water-based solution, preferentially the liquid is mains water, more preferentially the liquid is filtered and softened mains water. The second opening 11 is closed using the second closure means 110.

FIG. 6 illustrates the step of inflating the expandable element 2 within the pressurized gas storage tank for a vehicle 1. Air is introduced into the expandable element 2 by the air pipe 44 provided in the filling member 43 until reaching an air pressure of about 5 bar inside the expandable element. The liquid introduced into the bladder 20 in the preceding step remains at the bottom thereof. This inflation step makes it possible to achieve homogeneous stretching of the expandable element in order to ensure uniform contact between the expandable element and the inner wall of the tank 1, thus preventing creases from forming at the surface of the expandable element 2.

FIG. 7 illustrates the step of filling the expandable element 2 within the pressurized gas storage tank for a vehicle 1. Liquid is introduced into the expandable element via the liquid pipe 3. During this filling, the expander allows the air contained in the expandable element 2 to be discharged, expelled by the liquid at a higher pressure than the air, by the air pipe 44 provided in the filling member 43. The air is kept under pressure by the expander during its discharge so as not to break the uniform contact between the expandable element 2 and the inner wall of the tank 1, established in the preceding step, during filling.

FIG. 8 illustrates the end of the filling step and the start of the pressurization, Pᵢₙₜ, of all the interior walls of the pressurized gas storage tank for a vehicle 1 by means of the expandable element 2 filled with liquid 6. The expandable element 2 in the form of a bladder 20 fills the entirety of the internal volume of the tank by being “glued” or pressed against the interior walls of the latter under the effect of the pressure exerted by the liquid 6. To this end, the filling member 43 is removed from the first coupling means 4 and replaced with a so-called “high pressure” sub-adapter making it possible to fill the expandable element 2 with the liquid at a high pressure. The tank is closed at its openings 10, 11. The opening 10, referred to as first opening, is closed by means of the coupling means 4 via the closure means 40. The second opening 11, for its part, is closed using the second closure means 110. The liquid pipe 3 is left inside the tank 1 and is left connected to the liquid circuit so as to apply pressure to the interior walls of the tank 1 which is equal to 1.5 times the working pressure or nominal pressure. The tank 1 is subjected to said pressure for a time that can range from at least one second to, in certain cases, 10 minutes.

The measurement of a possible deformation of the pressurized gas storage tank for a vehicle may be a dimensional measurement such as a measurement of the diameter and the length of the tank. This dimensional measurement can be carried out using a camera, a 3D scanner, a distance measurement using a laser or a probe of the LVDT (Linear Variable Differential Transformer) type, by contact with a comparator-type system. The measurement of a possible deformation of the pressurized gas storage tank for a vehicle may also be a volumetric measurement corresponding to the measurement of the amount of liquid added during the pressure increase.

The tank 1 is then emptied of the liquid 6 contained in the expandable element 2. This emptying operation can be carried out via the liquid pipe 3 using a pump. The expandable element 2 is then removed from the pressurized gas storage tank for a vehicle 1 via the at least one opening 10. Advantageously, the expandable element 2 is previously subjected to greater suction so as to press it against the liquid pipe 3.

Ideally, the device used to implement the method for measuring mechanical strength of a pressurized gas storage tank for a vehicle 1 is oriented vertically so that gravity assists with the uniform stretching of the expandable element 2, preferentially of the bladder 20 under the weight of the liquid 6. Preferentially, the internal geometry of the tank 1 has gentles shapes and curves in order to avoid locally greater stretching of the expandable element, preferentially of the bladder 20, which would risk tearing it. For example, if the test is carried out on a tank comprising two openings 10, 11, the second opening 11 is blocked so as to prevent the expandable element 2, preferentially the bladder 20, from being pinched in a sharp geometry, or from coming out through the second opening 11 and bursting. Advantageously, the second closure means 110 is used as a second jaw of a vice consisting of this second closure means and as first jaw the cannula 30 that also served as first stretching means 5 of the expandable element 2, said vice tightening the expandable element 2 and making it possible to secure the stretching of the expandable element 2, preferentially of the bladder, in this critical zone.

1. A method for measuring mechanical strength of a pressurized gas storage tank for a vehicle, the method comprising:
Providing a pressurized gas storage tank for a vehicle having at least one opening;
Stretching an expandable element in a lengthwise direction;
Introducing the expandable element into the pressurized gas storage tank for a vehicle via the opening;
Connecting the expandable element to a pipe for a liquid;
Filling the expandable element with a liquid;
Exerting a pressure, Pᵢₙₜ, on all interior walls of the pressurized gas storage tank for a vehicle by means of the expandable element filled with the liquid;
Measuring a possible deformation of the pressurized gas storage tank for a vehicle;
Emptying the liquid contained in the expandable element; and
Removing the expandable element from the pressurized gas storage tank for a vehicle via the opening.

2. The method of claim 1, wherein the expandable element is a bladder.

3. The method of claim 1, further comprising assembling a first coupling means to the expandable element.

4. The method of claim 3, wherein stretching the expandable element is carried out by at least one translational movement of a first stretching means with respect to the first coupling means.

5. The method of claim 4, wherein the first stretching means is a filling pipe for filling the expandable element with the liquid.

6. The method of claim 5, wherein the filling pipe for filling the expandable element with the liquid has an outside diameter smaller than an inside diameter of the opening.

7. The method claim 1, wherein the liquid is at least one selected from the group consisting of water and a water-based solution.

8. The method of claim 1, wherein the expandable element comprises a material which is at least one selected from the group consisting of acrylonitrile-butadiene rubber (NBR), hydrogenated acrylonitrile-butadiene rubber (HNBR), carboxylated nitrile (XNBR), ethylene-propylene-diene rubber (EPDM), vinyl-methyl polysiloxane silicone (VMQ), fluorinated rubber (FKM), perfluorinated rubber (FFKM), chloroprene (CR), polyacrylate (ACM), acrylate-ethylene (AEM) and natural rubber.

9. The method of claim 1, further comprising, before filling the expandable element with liquid, pre-filling the expandable element with liquid.

10. The method of claim 1, further comprising, before filling the expandable element with liquid, inflating the expandable element.

11. A device for measuring mechanical strength of a pressurized gas storage tank for a vehicle, comprising:
an expandable element configured to be inserted into the pressurized gas storage tank for a vehicle, said expandable element being configured to contain a liquid once inserted into the tank;
a first coupling means configured to be assembled with the expandable element, the first coupling means being configured to be connected to a first stretching means of the expandable element;
a liquid pipe configured to be connected to the first coupling means; and
means for discharging a gas contained in the expandable element and/or the tank.

12. The device of claim 11, wherein the expandable element is a bladder.

13. The device of claim 11, wherein the first stretching means is a rod.

14. The device of claim 13, wherein the rod is the liquid pipe.

15. The device of claim 11, further comprising a pump configured to discharge liquid contained in the expandable element.

16. The device of claim 11, wherein the expandable element comprises a zone for receiving the first coupling means.
